(19) United States
(12) Patent Application Publication
(10) Pub. No.: US 2011/0083956 A1
(43) Pub. Date: Apr. 14, 2011

(54) Continuous Method For Producing Fatty Acid Alkanol Amides

(75) Inventors: Matthias Krull, Harxheim (DE); Roman Morschhaeuser, Mainz (DE)

(73) Assignee: CLARIANT FINANCE (BVI) LIMITED, Tortola (VG)

(21) Appl. No.: 12/935,319

(22) PCT Filed: Mar. 18, 2009
(86) PCT No.: PCT/EP09/01985

§ 371 Date: Dec. 8, 2010

(30) Foreign Application Priority Data
Apr. 4, 2008 (DE) 102008017214.6
Mar. 18, 2009 (EP) PCT/EP2009/001985

(51) Int. Cl. B01J 19/12

(52) U.S. Cl. 204/157.81

(57) ABSTRACT

The invention relates to a continuous method for producing fatty acid alkanol amides, wherein at least one fatty acid of the formula (I)

R³—COOH (I)

where R³ is an optionally substituted aliphatic hydrocarbon radical with 5 to 50 carbon atoms, having at least one alkanol amine of the formula (II)

HNR¹R² (II)

where R¹ is a hydrocarbon radical carrying at least one hydroxyl group and having 1 to 50 carbon atoms and R² is hydrogen, R¹ or a hydrocarbon radical having 1 to 50 carbon atoms, is reacted into an ammonia salt, and said ammonia salt is subsequently reacted in a reaction tube, the longitudinal axis thereof being disposed in the propagation direction of the microwaves of a monomode microwave applicator, under the action of microwave radiation into fatty acid alkanol amide.

Fatty acid derivatives which bear functional groups with hydrophilic character find widespread use as surface-active substances. An important class of such surface-active substances is that of nonionic amphiphiles which are used to a great extent, for example, as emulsifiers, corrosion stabilizers, cooling lubricants in metalworking, as lubricity additives in the mineral oil industry, as antistats for polyolefins, and also as raw materials for the production of washing compositions, cleaning concentrates, detergents, cosmetics and pharmaceuticals.

Of particular interest in this context are especially fatty acid alkanolamides which bear at least one alkyl radical which is bonded via an amide group and is itself substituted by at least one hydroxyl group which imparts hydrophilic character. This hydroxyl group can also be derivatized further before the actual use, for example by reaction with alkylene oxides such as ethylene oxide, propylene oxide or butylene oxide, or by oxidation with suitable oxidizing agents. Such amides have a greatly increased hydrolysis stability compared to corresponding esters.

The industrial preparation of fatty acid alkanolamides has to date been reliant on costly and/or laborious preparation processes in order to achieve a yield of commercial interest. The common preparation processes require activated carboxylic acid derivatives, for example acid anhydrides, acid halides such as acid chlorides, or esters, which are reacted with hydroxyl-bearing amines, referred to hereinafter as alkanolamines, or an in situ activation of the reactants by the use of coupling reagents, for example N,N′-dicyclohexylcarbodiimide. These preparation processes give rise to amounts, large amounts in some cases, of undesired by-products such as alcohols, acids and salts, which have to be removed from the product and disposed of. However, the residues of these auxiliary products and by-products which remain in the products can cause very undesired effects in some cases. For example, halide ions and also acids lead to corrosion; some of the coupling reagents and the by-products formed thereby are toxic, sensitizing or even carcinogenic.

The desirable direct thermal condensation of carboxylic acid and alkanolamine does not lead to satisfactory results since different side reactions reduce the yield and in some cases also impair the product properties. One problem is the bifunctionality of the alkanolamines, which, as well as the amide formation, causes a considerable degree of ester formation. Since alkanolamine esters have different properties, for example a significantly lower hydrolysis stability and a lower solubility in water, they are undesired as a by-product in most applications. Furthermore, ester amides, in which both the amino and the hydroxyl group are acylated, in surfactant solutions lead to undesired turbidity. Although the ester content can be converted at least partly to amides by thermal treatment, the color and odor of the alkanolamides thus prepared is very often impaired owing to the long reaction times required for that purpose. Removal of the ester fractions and also of the ester amide fractions is, however, possible only with difficulty, if at all, owing to the usually very similar physical properties. Further undesired side reactions observed are, for example, decarboxylation of the carboxylic acid, and oxidation and also elimination reactions of the amino group during the long heating required to achieve high conversions. In general, these side reactions lead to colored by-products, for example as a result of oxidation of the amine, and it is impossible to prepare colorless products which are desired especially for cosmetic applications, with Hazen color numbers (to DIN/ISO 6271) of, for example, less than 250. The latter requires additional process steps, for example bleaching, which, however, itself requires the addition of further assistants and often leads to an equally undesired impairment of the odor of the amides, or to undesired by-products such as peroxides and degradation products thereof.

A more recent approach to the synthesis of amides is the microwave-supported conversion of carboxylic acids and amines to amides.

For instance, Gelens et al., Tetrahedron Letters 2005, 46 (21), 3751-3754, disclose a multitude of amides which have been synthesized with the aid of microwave radiation. These also include benzoic acid monoethanolamide, which is obtained with a yield of 66%. The syntheses were effected in 10 ml vessels.

Massicot et al., Synthesis 2001 (16), 2411-2444 describe the synthesis of diamides of tartaric acid on the mmol scale. In the amidation with ethanolamine, a 68% yield of diamide is achieved.

EP-A-0 884 305 discloses the amidation of 2-amino-1,3-octadecanediol with 2-hydroxystearic acid under microwave irradiation on the mmol scale, which gives ceramides with a yield of approx. 70%.

The scaleup of such microwave-supported reactions from the laboratory to an industrial scale and hence the development of plants suitable for production of several tonnes, for example several tens, several hundreds or several thousands of tonnes, per year with space-time yields of interest for industrial scale applications has, however, not been achieved to date. One reason for this is the penetration depth of microwaves into the reaction mixture, which is typically limited to several millimeters to a few centimeters, and causes restriction to small vessels especially in reactions performed in batchwise processes, or leads to very long reaction times in stirred reactors. The occurrence of discharge processes and plasma formation places tight limits on an increase in the field strength, which is desirable for the irradiation of large amounts of substance with microwaves, especially in the multimode units used with preference to date for scaleup of chemical reactions. Moreover, the inhomogeneity of the microwave field, which leads to local overheating of the reaction mixture and is caused by more or less uncontrolled reflections of the microwaves injected into the microwave oven at the walls thereof and the reaction mixture, presents problems in the scaleup in the multimode microwave units typically used. In addition, the microwave absorption coefficient of the reaction mixture, which often changes during the reaction, presents difficulties with regard to a safe and reproducible reaction regime.

C. Chen et al., J. Chem. Soc., Chem. Commun., 1990, 807-809, describe a continuous laboratory microwave reactor, in which the reaction mixture is conducted through a Teflon pipe coil mounted in a microwave oven. A similar continuous laboratory microwave reactor is described by Cablewski et al., J. Org. Chem. 1994, 59, 3408-3412 for performance of a wide variety of different chemical reactions. In neither case, however, does the multimode microwave allow upscaling to the industrial scale range. The efficacy thereof with regard to the microwave absorption of the reaction mixture is low owing to the microwave energy being more or less homogeneously distributed over the applicator space in multimode microwave applicators and not focused on the pipe coil. A significant increase in the microwave power injected leads to undesired plasma discharges. In addition, the spatial inhomogeneities in the microwave field which change with time and are referred to as hotspots make a safe and reproducible reaction regime on a large scale impossible.

Additionally known are monomode or single-mode microwave applicators, in which a single wave mode is employed, which propagates in only one three-dimensional direction and is focused onto the reaction vessel by waveguides of exact dimensions. These instruments do allow high local field strengths, but, owing to the geometric requirements (for example, the intensity of the electrical field is at its greatest at the wave crests thereof and approaches zero at the nodes), have to date been restricted to small reaction volumes (≦50 ml) on the laboratory scale.

A process was therefore sought for preparing fatty acid alkanolamides, in which fatty acid and alkanolamine can also be converted directly on the industrial scale under microwave irradiation to the alkanolamide. At the same time, maximum, i.e. up to quantitative, conversion rates shall be achieved. In particular, the proportion of by-products such as alkanolamine esters and ester amides shall be at a minimum. The process shall additionally enable a very energy-saving preparation of the fatty acid alkanolamides, which means that the microwave power used shall be absorbed substantially quantitatively by the reaction mixture and the process shall thus give a high energetic efficiency. The alkanolamides shall also have minimum intrinsic color. In addition, the process shall ensure a safe and reproducible reaction regime.

It has been found that, surprisingly, fatty acid alkanolamides can be prepared in industrially relevant amounts by direct reaction of fatty acids with alkanolamines in a continuous process by only briefly heating by means of irradiation with microwaves in a reaction tube whose longitudinal axis is in the direction of propagation of the microwaves of a monomode microwave applicator. At the same time, the microwave energy injected into the microwave applicator is virtually quantitatively absorbed by the reaction mixture. The process according to the invention additionally has a high level of safety in the performance and offers high reproducibility of the reaction conditions established. The alkanolamides prepared by the process according to the invention contain only insignificant proportions of alkanolamine esters and ester amides, if any. They exhibit a high purity and low intrinsic color not obtainable in comparison to by conventional preparation processes without additional process steps.

The invention provides a continuous process for preparing fatty acid alkanolamides by reacting at least one fatty acid of the formula I

R³—COOH (I)

in which R³ is an optionally substituted aliphatic hydrocarbon radical having 5 to 50 carbon atoms
with at least one alkanolamine of the formula II

HNR¹R² (II)

in which
R¹ is a hydrocarbon radical bearing at least one hydroxyl group and having 1 to 50 carbon atoms and
R² is hydrogen, R¹ or a hydrocarbon radical having 1 to 50 carbon atoms to give an ammonium salt and then converting this ammonium salt to the fatty acid alkanolamide under microwave irradiation in a reaction tube whose longitudinal axis is in the direction of propagation of the microwaves from a monomode microwave applicator.

The invention further provides fatty acid alkanolamides with a content of amino esters and ester amides of less than 5 mol %, preparable by reaction of at least one fatty acid of the formula I

R³—COOH (I)

in which R³ is an optionally substituted aliphatic hydrocarbon radical having 5 to 50 carbon atoms,
with at least one alkanolamine of the formula

HNR¹R² (II)

in which
R¹ is a hydrocarbon radical bearing at least one hydroxyl group and having 1 to 50 carbon atoms and
R² is hydrogen, R¹ or a hydrocarbon radical having 1 to 50 carbon atoms to give an ammonium salt and then converting this ammonium salt to the fatty acid alkanolamide under microwave irradiation in a reaction tube longitudinal axis whose is in the direction of propagation of the microwaves from a monomode microwave applicator.

Suitable fatty acids of the formula I are generally compounds which have at least one carboxyl group on an optionally substituted aliphatic hydrocarbon radical having 5 to 50 carbon atoms. In a preferred embodiment, the aliphatic hydrocarbon radical is an unsubstituted alkyl or alkenyl radical. In a further preferred embodiment, the aliphatic hydrocarbon radical is a substituted alkyl or alkenyl radical which bears one or more, for example two, three, four or more, further substituents. Suitable substituents are, for example, halogen atoms, halogenated alkyl radicals, C₁-C₅-alkoxy, for example methoxy, poly(C₁-C₅-alkoxy), poly(C₁-C₅-alkoxy)alkyl, carboxyl, ester, amide, cyano, nitrile, nitro, sulfo and/or aryl groups having 5 to 20 carbon atoms, for example phenyl groups, with the proviso that they are stable under the reaction conditions and do not enter into any side reactions, for example elimination reactions. The C₅-C₂₀ aryl groups may themselves in turn bear substituents, for example halogen atoms, halogenated alkyl radicals, C₁-C₂₀-alkyl, C₂-C₂₀-alkenyl, C₁-C₅-alkoxy, for example methoxy, ester, amide, cyano, nitrile and/or nitro groups. However, the aliphatic hydrocarbon radical R³ bears at most as many substituents as it has valences. In a specific embodiment, the aliphatic hydrocarbon radical R³ bears further carboxyl groups. Thus, the process according to the invention is equally suitable for amidating polycarboxylic acids having, for example, two, three, four or more carboxyl groups. The reaction of polycarboxylic acids with primary amines by the process according to the invention can also form imides.

Particular preference is given to fatty acids (I) which bear an aliphatic hydrocarbon radical having 6 to 30 carbon atoms and especially having 7 to 24 carbon atoms, for example having 8 to 20 carbon atoms. They may be of natural or synthetic origin. The aliphatic hydrocarbon radical may also contain heteroatoms, for example oxygen, nitrogen, phosphorus and/or sulfur, but preferably not more than one heteroatom per three carbon atoms.

The aliphatic hydrocarbon radicals may be linear, branched or cyclic. The carboxyl group may be bonded to a primary, secondary or tertiary carbon atom. It is preferably bonded to a primary carbon atom. The hydrocarbon radicals may be saturated or unsaturated. Unsaturated hydrocarbon radicals contain one or more C═C double bonds and preferably one, two or three C═C double bonds. There is preferably no double bond in the α,β position to the carboxyl group. For instance, the process according to the invention has been found to be particularly useful for preparation of amides of polyunsaturated fatty acids, since the double bonds of the unsaturated fatty acids are not attacked under the reaction conditions of the process according to the invention. Preferred cyclic aliphatic hydrocarbon radicals possess at least one ring with four, five, six, seven, eight or more ring atoms.

Suitable aliphatic fatty acids are, for example, hexanoic acid, cyclohexanoic acid, heptanoic acid, octanoic acid, decanoic acid, dodecanoic acid, tridecanoic acid, tetradecanoic acid, 12-methyltridecanoic acid, pentadecanoic acid, 13-methyltetradecanoic acid, 12-methyltetradecanoic acid, hexadecanoic acid, 14-methylpentadecanoic acid, heptadecanoic acid, 15-methylhexadecanoic acid, 14-methylhexadecanoic acid, octadecanoic acid, isooctadecanoic acid, eicosanoic acid, docosanoic acid and tetracosanoic acid, and also myristoleic acid, palmitoleic acid, hexadecadienoic acid, delta-9-cis-heptadecenoic acid, oleic acid, petroselic acid, vaccenic acid, linoleic acid, linolenic acid, gadoleic acid, gondoic acid, eicosadienoic acid, arachidonic acid, cetoleic acid, erucic acid, docosadienoic acid and tetracosenoic acid, and also dodecenylsuccinic acid, octadecenylsuccinic acid and mixtures thereof. Additionally suitable are fatty acid mixtures obtained from natural fats and oils, for example cottonseed oil, coconut oil, groundnut oil, safflower oil, corn oil, palm kernel oil, rapeseed oil, olive oil, mustardseed oil, soya oil, sunflower oil, and also tallow oil, bone oil and fish oil. Fatty acids or fatty acid mixtures likewise suitable for the process according to the invention are tall oil fatty acids, and also resin acids and naphthenic acids.

R¹ bears preferably 2 to 20 carbon atoms, for example 3 to 10 carbon atoms. Additionally preferably, R¹ is a linear or branched alkyl radical. This alkyl radical may be interrupted by heteroatoms such as oxygen or nitrogen. R¹ may bear one or more, for example two, three or more, hydroxyl groups. The hydroxyl group is, or the hydroxyl groups are each, present on a primary or secondary carbon atom of the hydrocarbon radical. In the case that R² is also R¹, preference is given to amines which bear a total of at most 5, and especially 1, 2 or 3, hydroxyl groups.

In a preferred embodiment, R¹ is a group of the formula III

—(B—O)ₘ—H (III)

in which
B is an alkylene radical having 2 to 10 carbon atoms and
m is from 1 to 500.

B is preferably a linear or branched alkylene radical having 2 to 5 carbon atoms, more preferably a linear or branched alkylene radical having 2 or 3 carbon atoms and especially a group of the formula —CH₂—CH₂—, —CH₂—CH₂—CH₂— and/or —CH(CH₃)—CH₂—.

m is preferably from 2 to 300 and is especially from 3 to 100. In a particularly preferred embodiment, m is 1 or 2. In the case of alkoxy chains where m≧3 and especially where m≧5, the alkoxy chain may be a block polymer chain which has alternating blocks of different alkoxy units, preferably ethoxy and propoxy units. The chain may also be one with a random sequence of the alkoxy units, or a homopolymer.

In a preferred embodiment, R² is hydrogen, C₁-C₃₀-alkyl, C₂-C₃₀-alkenyl, C₅-C₁₂-cycloalkyl, C₆-C₁₂-aryl, C₇-C₃₀-aralkyl or a heteroaromatic group having 5 to 12 ring members. The hydrocarbon radicals may contain heteroatoms, for example oxygen and/or nitrogen, and optionally substituents, for example halogen atoms, halogenated alkyl radicals, nitro, cyano, nitrile and/or amino groups. In a further preferred embodiment, R² is a group of the formula IV

—(B—O)ₘ—R⁵ (IV)

in which
B and m are each as defined for formula (III) and
R⁵ is a hydrocarbon radical having 1 to 24 carbon atoms, and especially alkyl, alkenyl, aryl or acyl radicals having 1 to 24 carbon atoms.

R² more preferably represents alkyl radicals having 1 to 20 carbon atoms, especially having 1 to 8 carbon atoms, and alkenyl radicals having 2 to 20 carbon atoms, especially having 2 to 8 carbon atoms. These alkyl and alkenyl radicals may be linear, branched or cyclic. Suitable alkyl and alkenyl radicals are, for example, methyl, ethyl, propyl, isopropyl, n-butyl, isobutyl, hexyl, cyclohexyl, decyl, dodecyl, tetradecyl, hexadecyl, octadecyl, isostearyl and oleyl.

In a further particularly preferred embodiment, R² is an alkyl radical having 1 to 4 carbon atoms, for example methyl or ethyl. In a specific embodiment, R² is hydrogen.

The process according to the invention is preferentially suitable for preparation of secondary fatty acid alkanolamides, i.e. for reaction of fatty acids with alkanolamines in which R¹ is a hydrocarbon radical bearing at least one hydroxyl group and having 1 to 50 carbon atoms and R² is hydrogen.

The process according to the invention is more preferentially suitable for preparation of tertiary fatty acid alkanolamides, i.e. for reaction of fatty acids with alkanolamines in which R¹ is a hydrocarbon radical bearing at least one hydroxyl group and having 1 to 50 carbon atoms and R² is a hydrocarbon radical having 1 to 50 carbon atoms or a hydrocarbon radical bearing at least one hydroxyl group and having 1 to 50 carbon atoms. The definitions of R¹ and R² may be the same or different. In a particularly preferred embodiment, the definitions of R¹ and R² are the same.

Examples of suitable alkanolamines are aminoethanol, 3-amino-1-propanol, isopropanolamine, N-methylaminoethanol, N-ethylaminoethanol, N-butylethanolamine, N-methylisopropanolamine, 2-(2-aminoethoxy)ethanol, 2-amino-2-methyl-1-propanol, 3-amino-2,2-dimethyl-1-propanol, 2-amino-2-hydroxymethyl-1,3-propanediol, diethanolamine, dipropanolamine, diisopropanolamine, di(diethylene glycol)amine, N-(2-aminoethyl)ethanolamine and also poly(ether)amines such as poly(ethylene glycol)amine and poly(propylene glycol)amine each having 4 to 50 alkylene oxide units.

The process is especially suitable for preparation of octanoic acid diethanolamide, lauric acid monoethanolamide, lauric acid diethanolamide, lauric acid diglycol amide, coconut fatty acid monoethanolamide, coconut fatty acid diethanolamide, coconut fatty acid diglycolamide, stearic acid monoethanolamide, stearic acid diethanolamide, stearic acid diglycolamide, tall oil fatty acid monoethanolamide, tall oil fatty acid diethanolamide and tall oil fatty acid diglycolamide.

In the process according to the invention, the fatty acid is preferably reacted with an at least equimolar amount of alkanolamine and more preferably with an excess of alkanolamine. The reaction between alkanolamine and fatty acid is accordingly preferably effected with molar ratios of at least 1:1 and preferably between 100:1 and 1.001:1, more preferably between 10:1 and 1.01:1, for example between 5:1 and 1.1:1, based in each case on the molar equivalents of carboxyl groups and amino groups in the reaction mixture. The carboxyl groups are converted virtually quantitatively to the amide. In a specific embodiment, fatty acid and amine are used in equimolar amounts.

The inventive preparation of the amides proceeds by reaction of fatty acid and alkanolamine to give the ammonium salt and subsequent irradiation of the salt with microwaves in a reaction tube whose longitudinal axis is in the direction of propagation of the microwaves in a monomode microwave applicator.

The salt is preferably irradiated with microwaves in a substantially microwave-transparent reaction tube within a hollow conductor connected to a microwave generator. The reaction tube is preferably aligned axially with the central axis of symmetry of the hollow conductor.

The hollow conductor which functions as the microwave applicator is preferably configured as a cavity resonator. Additionally preferably, the microwaves unabsorbed in the hollow conductor are reflected at the end thereof. Configuration of the microwave applicator as a resonator of the reflection type achieves a local increase in the electrical field strength at the same power supplied by the generator and increased energy exploitation.

The cavity resonator is preferably operated in E₀₁ₙ mode where n is an integer and specifies the number of field maxima of the microwave along the central axis of symmetry of the resonator. In this operation, the electrical field is directed in the direction of the central axis of symmetry of the cavity resonator. It has a maximum in the region of the central axis of symmetry and decreases to the value 0 toward the outer surface. This field configuration is rotationally symmetric about the central axis of symmetry. According to the desired flow rate of the reaction mixture through the reaction tube, the temperature required and the residence time required in the resonator, the length of the resonator is selected relative to the wavelength of the microwave radiation used. n is preferably an integer from 1 to 200, more preferably from 2 to 100, particularly from 4 to 50 and especially from 3 to 20, for example 3, 4, 5, 6, 7 or 8.

The microwave energy can be injected into the hollow conductor which functions as the microwave applicator through holes or slots of suitable dimensions. In an embodiment particularly preferred in accordance with the invention, the ammonium salt is irradiated with microwaves in a reaction tube present in a hollow conductor with a coaxial transition of the microwaves. Microwave devices particularly preferred from this process are formed from a cavity resonator, a coupling device for injecting a microwave field into the cavity resonator and with one orifice each on two opposite end walls for passage of the reaction tube through the resonator. The microwaves are preferably injected into the cavity resonator by means of a coupling pin which projects into the cavity resonator. The coupling pin is preferably configured as a preferably metallic inner conductor tube which functions as a coupling antenna. In a particularly preferred embodiment, this coupling pin projects through one of the end orifices into the cavity resonator. The reaction tube more preferably adjoins the inner conductor tube of the coaxial transition, and is especially conducted through the cavity thereof into the cavity resonator. The reaction tube is preferably aligned axially with a central axis of symmetry of the cavity resonator, for which the cavity resonator preferably has one central orifice each on two opposite end walls for passage of the reaction tube.

The microwaves can be fed into the coupling pin or into the inner conductor tube which functions as a coupling antenna, for example, by means of a coaxial connecting line. In a preferred embodiment, the microwave field is supplied to the resonator via a hollow conductor, in which case the end of the coupling pin projecting out of the cavity resonator is conducted into the hollow conductor through an orifice in the wall of the hollow conductor, and takes microwave energy from the hollow conductor and injects it into the resonator.

In a specific embodiment, the salt is irradiated with microwaves in a microwave-transparent reaction tube which is axially symmetric within an E₀₁ₙ round hollow conductor with a coaxial transition of the microwaves. In this case, the reaction tube is conducted through the cavity of an inner conductor tube which functions as a coupling antenna into the cavity resonator. In a further preferred embodiment, the salt is irradiated with microwaves in a microwave-transparent reaction tube which is conducted through an E₀₁ₙ cavity resonator with axial feeding of the microwaves, the length of the cavity resonator being such that n=2 or more field maxima of the microwave form. In a further preferred embodiment, the salt is irradiated with microwaves in a microwave-transparent reaction tube which is axially symmetric within a circular cylindrical E₀₁ₙ cavity resonator with a coaxial transition of the microwaves, the length of the cavity resonator being such that n=2 or more field maxima of the microwave form.

Microwave generators, for example the magnetron, the klystron and the gyrotron, are known to those skilled in the art.

The reaction tubes used to perform the process according to the invention are preferably manufactured from substantially microwave-transparent, high-melting material. Particular preference is given to using nonmetallic reaction tubes. “Substantially microwave-transparent” is understood here to mean materials which absorb a minimum amount of microwave energy and convert it to heat. A measure employed for the ability of a substance to absorb microwave energy and convert it to heat is often the dielectric loss factor tan δ=ε″/ε′. The dielectric loss factor tan δ is defined as the ratio of dielectric loss ε″ to dielectric constant ε′. Examples of tan δ values of different materials are reproduced, for example, in D. Bogdal, Microwave-assisted Organic Synthesis, Elsevier 2005. For reaction tubes suitable in accordance with the invention, materials with tan δ values measured at 2.45 GHz and 25° C. of less than 0.01, particularly less than 0.005 and especially less than 0.001 are preferred. Preferred microwave-transparent and thermally stable materials include primarily mineral-based materials, for example quartz, aluminum oxide, zirconium oxide and the like. Other suitable tube materials are thermally stable plastics, such as especially fluoropolymers, for example Teflon, and industrial plastics such as polypropylene, or polyaryl ether ketones, for example glass fiber-reinforced polyetheretherketone (PEEK). In order to withstand the temperature conditions during the reaction, minerals, such as quartz or aluminum oxide, coated with these plastics have been found to be especially suitable as reactor materials.

Reaction tubes particularly suitable for the process according to the invention have an internal diameter of 1 mm to approx. 50 cm, especially between 2 mm and 35 cm for example between 5 mm and 15 cm. Reaction tubes are understood here to mean vessels whose ratio of length to diameter is greater than 5, preferably between 10 and 100 000, more preferably between 20 and 10 000, for example between 30 and 1000. A length of the reaction tube is understood here to mean the length of the reaction tube over which the microwave irradiation proceeds. Baffles and/or other mixing elements can be incorporated into the reaction tube.

E₀₁ cavity resonators particularly suitable for the process according to the invention preferably have a diameter which corresponds to at least half the wavelength of the microwave radiation used. The diameter of the cavity resonator is preferably 1.0 to 10 times, more preferably 1.1 to 5 times and especially 2.1 to 2.6 times half the wavelength of the microwave radiation used. The E₀₁ cavity resonator preferably has a round cross section, which is also referred to as an E₀₁ round hollow conductor. It more preferably has a cylindrical shape and especially a circular cylindrical shape.

The reaction tube is typically provided at the inlet with a metering pump and a manometer, and at the outlet with a pressure-retaining device and a heat exchanger. This makes possible reactions within a very wide pressure and temperature range.

The conversion of amine and fatty acid to the ammonium salt can be performed continuously, batchwise or else in semibatchwise processes. Thus, the preparation of the ammonium salt can be performed in an upstream (semi)-batchwise process, for example in a stirred vessel. The ammonium salt is preferably obtained in situ and not isolated. In a preferred embodiment, the amine and fatty acid reactants, each independently optionally diluted with solvent, are only mixed shortly before entry into the reaction tube. For instance, it has been found to be particularly useful to undertake the reaction of amine and fatty acid to give the ammonium salt in a mixing zone, from which the ammonium salt, optionally after intermediate cooling, is conveyed into the reaction tube. Additionally preferably, the reactants are supplied to the process according to the invention in liquid form. For this purpose, it is possible to use relatively high-melting and/or relatively high-viscosity reactants, for example in the molten state and/or admixed with solvent, for example in the form of a solution, dispersion or emulsion. A catalyst can, if used, be added to one of the reactants or else to the reactant mixture before entry into the reaction tube. It is also possible to convert solid, pulverulent and heterogeneous systems by the process according to the invention, in which case merely appropriate industrial apparatus for conveying the reaction mixture is required.

The ammonium salt can be fed into the reaction tube either at the end conducted through the inner conductor tube or at the opposite end.

By variation of tube cross section, length of the irradiation zone (this is understood to mean the length of the reaction tube in which the reaction mixture is exposed to microwave radiation), flow rate, geometry of the cavity resonator, the microwave power injected and the temperature achieved, the reaction conditions are established such that the maximum reaction temperature is attained as rapidly as possible and the residence time at maximum temperature remains sufficiently short that as low as possible a level of side reactions or further reactions occurs. To complete the reaction, the reaction mixture can pass through the reaction tube more than once, optionally after intermediate cooling. In many cases, it has been found to be useful when the reaction product is cooled immediately after leaving the reaction tube, for example by jacket cooling or decompression. In the case of slower reactions, it has often been found to be useful to keep the reaction product at reaction temperature for a certain time after it leaves the reaction tube.

The advantages of the process according to the invention lie in very homogeneous irradiation of the reaction mixture in the center of a symmetric microwave field within a reaction tube, the longitudinal axis of which is in the direction of propagation of the microwaves of a monomode microwave applicator and especially within an E₀₁ cavity resonator, for example with a coaxial transition. The inventive reactor design allows the performance of reactions also at very high pressures and/or temperatures. By increasing the temperature and/or pressure, a significant rise in the degree of conversion and yield is observed even compared to known microwave reactors, without this resulting in undesired side reactions and/or discoloration. Surprisingly, this achieves a very high efficiency in the exploitation of the microwave energy injected into the cavity resonator, which is typically more than 50%, often more than 80%, in some cases more than 90% and in special cases more than 95%, for example more than 98%, of the microwave power injected, and therefore gives economic and also ecological advantages over conventional preparation processes, and also over prior art microwave processes.

The process according to the invention additionally allows a controlled, safe and reproducible reaction regime. Since the reaction mixture in the reaction tube is moved parallel to the direction of propagation of the microwaves, known overheating phenomena as a result of uncontrolled field distributions, which lead to local overheating as a result of changing intensities of the field, for example in wave crests and nodes, are balanced out by the flowing motion of the reaction mixture. The advantages mentioned also allow working with high microwave powers of, for example, more than 10 kW or more than 100 kW and thus, in combination with only a short residence time in the cavity resonator, accomplishment of large production amounts of 100 or more tonnes per year in one plant.

It was particularly surprising that, in spite of the only very short residence time of the ammonium salt in the microwave field in the flow tube with continuous flow, very substantial amidation takes place with conversions generally of more than 80%, often even more than 90%, for example more than 95%, based on the component used in deficiency, without significant formation of by-products. In the case of a corresponding conversion of these ammonium salts in a flow tube, of the same dimensions with thermal jacket heating, achievement of suitable reaction temperatures requires extremely high wall temperatures which lead to formation of colored species, but only minor amide formation in the same time interval.

The temperature rise caused by the microwave radiation is preferably limited to a maximum of 500° C., for example, by regulating the microwave intensity of the flow rate and/or by cooling the reaction tube, for example by means of a nitrogen stream. It has been found to be particularly useful to perform the reaction at temperatures between 150 and a maximum of 400° C. and especially between 180 and a maximum of 300° C., for example at temperatures between 200 and 270° C.

The duration of the microwave irradiation depends on various factors, for example the geometry of the reaction tube, the microwave energy injected, the specific reaction and the desired degree of conversion. Typically, the microwave irradiation is undertaken over a period of less than 30 minutes, preferably between 0.01 second and 15 minutes, more preferably between 0.1 second and 10 minutes and especially between 1 second and 5 minutes, for example between 5 seconds and 2 minutes. The intensity (power) of the microwave radiation is adjusted such that the reaction mixture has the desired maximum temperature when it leaves the cavity resonator. In a preferred embodiment, the reaction product, directly after the microwave irradiation has ended, is cooled as rapidly as possible to temperatures below 120° C., preferably below 100° C. and especially below 60° C.

The reaction is preferably performed at pressures between 0.01 and 500 bar and more preferably between 1 bar (atmospheric pressure) and 150 bar and especially between 1.5 bar and 100 bar, for example between 3 bar and 50 bar. It has been found to be particularly useful to work under elevated pressure, which involves working above the boiling point (at standard pressure) of the reactants or products, or of any solvent present, and/or above the water of reaction formed during the reaction. The pressure is more preferably adjusted to a sufficiently high level that the reaction mixture remains in the liquid state during the microwave irradiation and does not boil.

To avoid side reactions and to prepare products of maximum purity, it has been found to be useful to handle reactants and products in the presence of an inert protective gas, for example nitrogen, argon or helium.

In a preferred embodiment, the reaction is accelerated or completed by working in the presence of dehydrating catalysts. Preference is given to working in the presence of an acidic inorganic, organometallic or organic catalyst, or mixtures of two or more of these catalysts.

Acidic inorganic catalysts in the context of the present invention include, for example, sulfuric acid, phosphoric acid, phosphonic acid, hypophosphorous acid, aluminum sulfide hydrate, alum, acidic silica gel and acidic aluminum hydroxide. In addition, for example, aluminum compounds of the general formula Al(OR¹⁵)₃ and titanates of the general formula Ti(OR¹⁵)₄ are usable as acidic inorganic catalysts, where R¹⁵ radicals may each be the same or different and are each independently selected from C₁-C₁₀ alkyl radicals, for example methyl, ethyl, n-propyl, isopropyl, n-butyl, isobutyl, sec-butyl, tert-butyl, n-pentyl, isopentyl, sec-pentyl, neo-pentyl, 1,2-dimethylpropyl, isoamyl, n-hexyl, sec-hexyl, n-heptyl, n-octyl, 2-ethylhexyl, n-nonyl or n-decyl, C₃-C₁₂ cycloalkyl radicals, for example cyclopropyl, cyclobutyl, cyclopentyl, cyclohexyl, cycloheptyl, cyclooctyl, cyclononyl, cyclodecyl, cycloundecyl and cyclododecyl; preference is given to cyclopentyl, cyclohexyl and cycloheptyl. The R¹⁵ radicals in Al(OR¹⁵)₃ or Ti(OR¹⁵)₄ are preferably each the same and are selected from isopropyl, butyl and 2-ethylhexyl.

Preferred acidic organometallic catalysts are, for example, selected from dialkyltin oxides (R¹⁵)₂SnO, where R¹⁵ is as defined above. A particularly preferred representative of acidic organometallic catalysts is di-n-butyltin oxide, which is commercially available as “Oxo-tin” or as Fascat® brands.

Preferred acidic organic catalysts are acidic organic compounds with, for example, phosphate groups, sulfo groups, sulfate groups or phosphonic acid groups. Particularly preferred sulfonic acids contain at least one sulfo group and at least one saturated or unsaturated, linear, branched and/or cyclic hydrocarbon radical having 1 to 40 carbon atoms and preferably having 3 to 24 carbon atoms. Especially preferred are aromatic sulfonic acids, especially alkylaromatic monosulfonic acids having one or more C₁-C₂₈ alkyl radicals and especially those having C₃-C₂₂ alkyl radicals. Suitable examples are methanesulfonic acid, butanesulfonic acid, benzenesulfonic acid, p-toluenesulfonic acid, xylenesulfonic acid, 2-mesitylenesulfonic acid, 4-ethylbenzenesulfonic acid, isopropylbenzenesulfonic acid, 4-butylbenzenesulfonic acid, 4-octylbenzenesulfonic acid; dodecylbenzenesulfonic acid, didodecylbenzenesulfonic acid, naphthalenesulfonic acid. It is also possible to use acidic ion exchangers as acidic organic catalysts, for example sulfo-containing poly(styrene) resins crosslinked with about 2 mol % of divinylbenzene.

Particular preference for the performance of the process according to the invention is given to boric acid, phosphoric acid, polyphosphoric acid and polystyrenesulfonic acids. Especially preferred are titanates of the general formula Ti(OR¹⁵)₄, and especially titanium tetrabutoxide and titanium tetraisopropoxide.

If the use of acidic inorganic, organometallic or organic catalysts is desired, in accordance with the invention, 0.01 to 10% by weight, preferably 0.02 to 2% by weight, of catalyst is used. In a particularly preferred embodiment, no catalyst is employed.

In a further preferred embodiment, the microwave irradiation is performed in the presence of acidic solid catalysts. This involves suspending the solid catalyst in the ammonium salt optionally admixed with solvent, or advantageously passing the ammonium salt optionally admixed with solvent over a fixed bed catalyst and exposing it to microwave radiation. Suitable solid catalysts are, for example, zeolites, silica gel, montmorillonite and (partly) crosslinked polystyrenesulfonic acid, which may optionally be integrated with catalytically active metal salts. Suitable acidic ion exchangers based on polystyrenesulfonic acids, which can be used as solid phase catalysts, are obtainable, for example, from Rohm & Haas under the Amberlyst® brand name.

It has been found to be useful to work in the presence of solvents in order, for example, to lower the viscosity of the reaction medium and/or to fluidize the reaction mixture if it is heterogeneous. For this purpose, it is possible in principle to use all solvents which are inert under the reaction conditions employed and do not react with the reactants or the products formed. An important factor in the selection of suitable solvents is the polarity thereof, which firstly determines the dissolution properties and secondly the degree of interaction with microwave radiation. A particularly important factor in the selection of suitable solvents is the dielectric loss ε″ thereof. The dielectric loss ε″ describes the proportion of microwave radiation which is converted to heat in the interaction of a substance with microwave radiation. The latter value has been found to be a particularly important criterion for the suitability of a solvent for the performance of the process according to the invention. It has been found to be particularly useful to work in solvents which exhibit minimum microwave absorption and hence make only a small contribution to the heating of the reaction system. Solvents preferred for the process according to the invention have a dielectric loss ε″ measured at room temperature and 2450 MHz of less than 10 and preferably less than 1, for example less than 0.5. An overview of the dielectric loss of different solvents can be found, for example, in “Microwave Synthesis” by B. L. Hayes, CEM Publishing 2002. Suitable solvents for the process according to the invention are especially those with ε″ values less than 10, such as N-methylpyrrolidone, N,N-dimethylformamide or acetone, and especially solvents with ε″ values less than 1. Examples of particularly preferred solvents with ε″ values less than 1 are aromatic and/or aliphatic hydrocarbons, for example toluene, xylene, ethylbenzene, tetralin, hexane, cyclohexane, decane, pentadecane, decalin, and also commercial hydrocarbon mixtures, such as benzine fractions, kerosene, Solvent Naphtha, Shellsol® AB, Solvesso® 150, Solvesso® 200, Exxsol®, Isopar® and Shellsol® products. Solvent mixtures which have ε″ values preferably below 10 and especially below 1 are equally preferred for the performance of the process according to the invention.

In principle, the process according to the invention is also performable in solvents with higher ε″ values of, for example, 5 or higher, such as especially with ε″ values of 10 or higher. However, the accelerated heating of the reaction mixture observed requires special measures to comply with the maximum temperature.

When working in the presence of solvents, the proportion thereof in the reaction mixture is preferably between 2 and 95% by weight, especially between 5 and 90% by weight and particularly between 10 and 75% by weight, for example between 30 and 60% by weight. Particular preference is given to performing the reaction without solvents.

Microwaves refer to electromagnetic rays with a wavelength between about 1 cm and 1 m, and frequencies between about 300 MHz and 30 GHz. This frequency range is suitable in principle for the process according to the invention. For the process according to the invention, preference is given to using microwave radiation with the frequencies approved for industrial, scientific and medical applications, for example with frequencies of 915 MHz, 2.45 GHz, 5.8 GHz or 27.12 GHz.

The microwave power to be injected into the cavity resonator for the performance of the process according to the invention is especially dependent on the geometry of the reaction tube and hence of the reaction volume, and on the duration of the irradiation required. It is typically between 200 W and several hundred kW and especially between 500 W and 100 kW for example between 1 kW and 70 kW. It can be generated by means of one or more microwave generators.

In a preferred embodiment, the reaction is performed in a pressure-resistant inert tube, in which case the water of reaction which forms and possibly reactants and, if present, solvent lead to a pressure buildup. After the reaction has ended, the elevated pressure can be used by decompression for volatilization and removal of water of reaction, excess reactants and any solvent and/or to cool the reaction product. In a further embodiment, the water of reaction formed, after cooling and/or decompression, is removed by customary processes, for example phase separation, distillation, stripping, flashing and/or absorption.

To complete the conversion, it has in many cases been found to be useful to expose the crude product obtained, after removal of water of reaction and if appropriate discharge of product and/or by-product, again to microwave irradiation, in which case the ratio of the reactants used may have to be supplemented to replace consumed or deficient reactants.

Alkanolamides prepared via the inventive route are typically obtained in a purity sufficient for further use. For specific requirements, they can, however, be purified further by customary purification processes, for example distillation, recrystallization, filtration or chromatographic processes.

The process according to the invention allows a very rapid, energy-saving and inexpensive preparation of fatty acid alkanolamides in high yields and with high purity in industrial scale amounts. The very homogeneous irradiation of the ammonium salt in the center of the rotationally symmetric microwave field allows a safe, controllable and reproducible reaction regime. At the same time, a very high efficiency in the exploitation of the incident microwave energy achieves an economic viability distinctly superior to the known preparation processes. In this process, no significant amounts of by-products are obtained.

More particularly, the alkanolamides prepared by the process according to the invention have only a low content of alkanolamine esters and of ester amides. The aqueous solutions thereof are therefore clear and have, in contrast to corresponding fatty acid alkanolamides prepared by thermal condensation, no turbidity caused by ester amides. The intrinsic color of the amides prepared in accordance with the invention corresponds to Hazen color numbers (to DIN/ISO 6271) of less than 200 and in some cases less than 150, for example less than 100, whereas Hazen color numbers below 250 are not obtainable by conventional methods without additional process steps. Since the alkanolamides prepared by the process according to the invention, in addition, contain no residues of coupling reagents or conversion products thereof as a result of the process, it can also be used without difficulty in toxicologically sensitive sectors, for example cosmetic and pharmaceutical formulations.

The alkanolamides prepared in accordance with the invention contain, based on the entirety of the fatty acids and fatty acid derivatives present, preferably less than 5 mol %, especially less than 2 mol % and particularly virtually no esters or ester amides resulting from the acylation of the hydroxyl group of the alkanolamine. “Containing virtually no esters and alkanolamine esters” is understood to mean alkanolamides whose total content of esters and ester amides is less than 1 mol % and cannot be detected by customary analysis methods, for example ¹H NMR spectroscopy.

Such rapid and selective reactions cannot be achieved by conventional methods and were not to be expected solely through heating to high temperatures. The products prepared by the process according to the invention are often so pure that no further workup or further processing steps are required.

### EXAMPLES

The conversions of the ammonium salts under microwave irradiation were effected in a ceramic tube (60×1 cm) which was present in axial symmetry in a cylindrical cavity resonator (60×10 cm). On one of the end sides of the cavity resonator, the ceramic tube passed through the cavity of an inner conductor tube which functions as a coupling antenna. The microwave field with a frequency of 2.45 GHz, generated by a magnetron, was injected into the cavity resonator by means of the coupling antenna (E₀₁ cavity applicator; monomode).

The microwave power was in each case adjusted over the experiment time in such a way that the desired temperature of the reaction mixture at the end of the irradiation zone was kept constant. The microwave powers mentioned in the experiment descriptions therefore represent the mean value of the microwave power injected over time. The measurement of the temperature of the reaction mixture was undertaken directly after it had left the reaction zone (distance about 15 cm in an insulated stainless steel capillary, Ø 1 cm) by means of a Pt100 temperature sensor. Microwave energy not absorbed directly by the reaction mixture was reflected at the end side of the cavity resonator at the opposite end to the coupling antenna; the microwave energy which was also not absorbed by the reaction mixture on the return path and reflected back in the direction of the magnetron was passed with the aid of a prism system (circulator) into a water-containing vessel. The difference between energy injected and heating of this water load was used to calculate the microwave energy introduced into the reaction mixture.

By means of a high-pressure pump and of a suitable pressure-release valve, the reaction mixture in the reaction tube was placed under such a working pressure which was sufficient always to keep all reactants and products or condensation products in the liquid state. The ammonium salts prepared from fatty acid and amine were pumped with a constant flow rate through the reaction tube, and the residence time in the irradiation zone was adjusted by modifying the flow rate.

The products were analyzed by means of ¹H NMR spectroscopy at 500 MHz in CDCl₃. The properties were determined by means of atomic absorption spectroscopy.

### Example 1

### Preparation of Coconut Fatty Acid Monoethanolamide

A 10 liter Büchi stirred autoclave was initially charged with 5.1 kg of molten coconut fatty acid (25 mol), and 1.5 kg of ethanolamine (25 mol) were added slowly while cooling gently. In an exothermic reaction, the coconut fatty acid ethanolammonium salt formed.

The ammonium salt thus obtained was pumped in the molten state through the reaction tube continuously with a flow rate of 5 l/h at 120° C. and a working pressure of 25 bar and exposed to a microwave power of 2.2 kW, 90% of which was absorbed by the reaction mixture. The residence time of the reaction mixture in the irradiation zone was approx. 34 seconds. At the end of the reaction tube, the reaction mixture had a temperature of 265° C.

A conversion of 94% of theory was attained. The reaction product was virtually colorless. After distillative removal of water of reaction and excess ethanolamine, 6.0 kg of coconut fatty acid monoethanolamide were obtained with a purity of 93.5%. The coconut fatty acid monoethanolamide thus obtained contained a total of less than 1 mol % of amino ester and ester amide.

### Example 2

### Preparation of N-(2-Hydroxyethyl)Lauramide

A 10 liter Büchi stirred autoclave was initially charged with 4.00 kg of molten lauric acid (20 mol), and 1.34 kg of ethanolamine (22 mol) were added slowly while cooling. In an exothermic reaction, the lauric acid monoethanolammonium salt formed.

The ammonium salt thus obtained was pumped in the molten state through the reaction tube continuously with a flow rate of 5 l/h at 120° C. and a working pressure of 25 bar and exposed to a microwave power of 2.2 kW, 92% of which was adsorbed by the reaction mixture. The residence time of the reaction mixture in the irradiation zone was approx. 34 seconds. At the end of the reaction tube, the reaction mixture had a temperature of 270° C.

A conversion of 96% of theory was attained. The reaction product was pale yellowish in color. After distillative removal of water of reaction and excess ethanolamine, 4.7 kg of N-(2-hydroxyethyl)lauramide were obtained with a purity of 95%. The lauric acid N-monoethanolamide thus obtained contained a total of 1.5 mol % of amino ester and ester amide.

### Example 3

### Reaction of Lauric Acid With 2-(2-Aminoethoxy)Ethanol

A 10 liter Büchi stirred autoclave was initially charged with 4.00 kg of molten lauric acid (20 mol), and 2.1 kg of 2-(2-aminoethoxy)ethanol (20 mol) were added slowly while cooling gently. In an exothermic reaction, the ammonium salt formed.

The ammonium salt thus obtained was pumped in the molten state through the reaction tube continuously with a flow rate of 4 l/h at 90° C. and a working pressure of 20 bar and exposed to a microwave power of 2.9 kW, 95% of which was absorbed by the reaction mixture. The residence time of the reaction mixture in the irradiation zone was approx. 42 seconds. At the end of the reaction tube, the reaction mixture had a temperature of 265° C.

A conversion of 95% of theory was attained. The reaction product was yellowish in color. After distillative removal of the water of reaction, 5.6 kg of N-lauroyl-2-(2-aminoethoxy)ethanolamide were obtained with a purity of 94%. The N-lauroyl-2-(2-aminoethoxy)ethanolamide thus obtained contained less than 1 mol % of amino ester and ester amide.

### Example 4

### Preparation of Bis(2-Hydroxyethyl)Oleamide

A 10 liter Büchi stirred autoclave was initially charged with 5.65 kg of technical-grade oleic acid (20 mol), and 2.1 kg of diethanolamine (20 mol) were added slowly while cooling gently. In an exothermic reaction, the oleic acid diethanolammonium salt formed.

The ammonium salt thus obtained was pumped in the molten state through the reaction tube continuously with a flow rate of 9.3 l/h at 100° C. and a working pressure of 25 bar and exposed to a microwave power of 3.5 kW, 93% of which was absorbed by the reaction mixture. The residence time of the reaction mixture in the irradiation zone was approx. 18 seconds. At the end of the reaction tube, the reaction mixture had a temperature of 275° C.

A conversion of 96% of theory was attained. The reaction product was yellowish in color. After distillative removal of water of reaction, 7.1 kg of bis(2-hydroxyethyl)oleamide were obtained with a purity of 95%. The bis(2-hydroxyethyl)oleamide thus obtained contained a total of less than 1 mol % of amino ester and ester amide. The ¹H NMR signals of the olefinic protons of the product were unchanged compared to the oleic acid used with regard to splitting pattern and integrals.

### Example 5

### Preparation of Coconut Fatty Acid Diethanolamide

A 10 liter Büchi stirred autoclave was initially charged with 5.1 kg of molten coconut fatty acid (25 mol), and 2.6 kg of diethanolamine (25 mol) were added slowly while cooling gently. In an exothermic reaction, the coconut fatty acid diethanolammonium salt formed.

The ammonium salt thus obtained was pumped in the molten state through the reaction tube continuously with a flow rate of 5 l/h at 110° C. and a working pressure of 25 bar and exposed to a microwave power of 2.0 kW, 92% of which was absorbed by the reaction mixture. The residence time of the reaction mixture in the irradiation zone was approx. 34 seconds. At the end of the reaction tube, the reaction mixture had a temperature of 270° C.

A conversion of 92% of theory was attained. The reaction product was virtually colorless. After distillative removal of water of reaction and excess diethanolamine, 7.1 kg of coconut fatty acid monoethanolamide were obtained with a purity of 91%. The coconut fatty acid monoethanolcocoamide thus obtained contained a total of less than 1 mol % of amino ester and ester amide.

1. A continuous process for preparing fatty acid alkanolamides by reacting at least one fatty acid of the formula I
R³—COOH (I)
in which R³ is an optionally substituted aliphatic hydrocarbon radical having 5 to 50 carbon atoms
with at least one alkanolamine of the formula II
HNR¹R² (II)
in which
R¹ is a hydrocarbon radical bearing at least one hydroxyl group and having 1 to 50 carbon atoms and
R² is hydrogen, R¹ or a hydrocarbon radical having 1 to 50 carbon atoms to give an ammonium salt and then converting this ammonium salt to the fatty acid alkanolamide under microwave irradiation in a reaction tube whose longitudinal axis is in the direction of propagation of the microwaves from a monomode microwave applicator.

2. The process as claimed in claim 1, in which the salt is irradiated with microwaves in a substantially microwave-transparent reaction tube within a hollow conductor connected via waveguides to a microwave generator.

3. The process as claimed in one or more of claims 1 and 2, in which the microwave applicator is configured as a cavity resonator.

4. The process as claimed in one or more of claims 1 to 3, in which the microwave applicator is configured as a cavity resonator of the reflection type.

5. The process as claimed in one or more of claims 1 to 4, in which the reaction tube is aligned axially with a central axis of symmetry of the hollow conductor.

6. The process as claimed in one or more of claims 1 to 5, in which the salt is irradiated in a cavity resonator with a coaxial transition of the microwaves.

7. The process as claimed in one or more of claims 1 to 6, in which the cavity resonator is operated in E₀₁ₙ mode where n is an integer from 1 to 200.

8. The process as claimed in one or more of claims 1 to 7, in which R³ is an unsubstituted alkyl radical having 5 to 50 carbon atoms.

9. The process as claimed in one or more of claims 1 to 7, in which R³ is a hydrocarbon radical which has 5 to 50 carbon atoms and bears one or more substituents selected from halogen atoms, halogenated alkyl radicals, C₁-C₅-alkoxy, poly(C₁-C₅-alkoxy), poly(C₁-C₅-alkoxy)alkyl, carboxyl, ester, amide, cyano, nitrile, nitro, sulfo and aryl groups having 5 to 20 carbon atoms, where the C₅-C₂₀-aryl groups may bear substituents selected from halogen atoms, halogenated alkyl radicals, C₁-C₂₀-alkyl, C₂-C₂₀-alkenyl, C₁-C₅-alkoxy, ester, amide, cyano, nitrile and nitro groups.

10. The process as claimed in one or more of claims 1 to 9, in which R³ comprises 5 to 30 carbon atoms.

11. The process as claimed in one or more of claims 1 to 10, in which R³ comprises one or more double bonds.

12. The process as claimed in one or more of claims 1 to 11, in which R¹ bears 2 to 20 carbon atoms.

13. The process as claimed in one or more of claims 1 to 12, in which R¹ is a group of the formula III
—(B—O)ₘ—H (III)
in which
B is an alkylene radical having 2 to 10 carbon atoms and
m is from 1 to 500.

14. The process as claimed in one or more of claims 1 to 13, in which R² is C₁-C₃₀-alkyl, C₂-C₃₀-alkenyl, C₅-C₁₂-cycloalkyl, C₆-C₁₂-aryl, C₇-C₃₀-aralkyl or a heteroaromatic group having 5 to 12 ring members.

15. The process as claimed in one or more of claims 1 to 13, in which R² is a group of the formula IV
—(B—O)ₘ—R⁵ (IV)
in which
B is an alkylene radical having 2 to 10 carbon atoms,
m is from 1 to 500, and
R⁵ is a hydrocarbon radical having 1 to 24 carbon atoms.

16. The process as claimed in one or more of claims 1 to 13, in which R² is hydrogen.

17. The process as claimed in one or more of claims 1 to 15, in which R² represents alkyl radicals having 1 to 20 carbon atoms or alkenyl radicals having 2 to 20 carbon atoms.

18. The process as claimed in one or more of claims 1 to 17, in which the microwave irradiation is performed at temperatures between 150 and 500° C.

19. The process as claimed in one or more of claims 1 to 18, in which the microwave irradiation is performed at pressures above atmospheric pressure.

20. A fatty acid alkanolamide with a content of amino esters and ester amides of less than 5 mol %, prepared by reaction of at least one fatty acid of the formula I
R³—COOH (I)
in which R³ is an optionally substituted aliphatic hydrocarbon radical having 4 to 50 carbon atoms
with at least one alkanolamine of the formula
HNR¹R² (II)
in which
R¹ is a hydrocarbon radical bearing at least one hydroxyl group and having 1 to 50 carbon atoms and
R² is hydrogen, R¹ or a hydrocarbon radical having 1 to 50 carbon atoms to give an ammonium salt, and then converting this ammonium salt to the fatty acid alkanolamide with microwave irradiation in a reaction tube, the longitudinal axis of which is in the direction of propagation of the microwaves from a monomode microwave applicator.
